(19) United States
(12) Patent Application Publication
(10) Pub. No.: US 2022/0134580 A1
(43) Pub. Date: May 5, 2022

(54) ROBOT ARM AND ROBOT ARM MANUFACTURING METHOD

(71) Applicant: OMRON Corporation, KYOTO (JP)

(72) Inventor: Takeshi KIRIBUCHI, Osaka-shi, OSAKA (JP)

(73) Assignee: OMRON Corporation, KYOTO (JP)

(21) Appl. No.: 17/284,773

(22) PCT Filed: Oct. 21, 2019
(86) PCT No.: PCT/JP2019/041239

§ 371 Date: Apr. 12, 2021

(30) Foreign Application Priority Data
Nov. 5, 2018 (JP) 2018-208145

(51) Int. Cl. B25J 18/00; B25J 9/00

(52) U.S. Cl. CPC B25J 18/00; B25J 9/0009

(57) ABSTRACT

A robot arm (100a-100d) comprises an arm member (10) and at least two wires (20a-20d). The two wires (20a-20d) have a configuration wherein: each wire has a flat shape and the wires are disposed in parallel in a state of facing each other in a direction perpendicular to the flat shape face; a shield wire (S1) is provided around each wire; each wire has a helical shape; or the wires are twisted together.

### TECHNICAL FIELD

The present invention relates to a robot arm and a robot arm manufacturing method.

### BACKGROUND ART

As a related art, a work robot including a robot arm configured with a plurality of arm members is known. For example, Patent Literature 1 discloses a work robot including a plurality of arm members sequentially provided from a proximal end side to a distal end side and joint shafts interposed between the arm members.

### CITATION LIST

### Patent Literature

### [Patent Literature 1]

Japanese Patent Laid-Open No. 2009-113188 (published on May 28, 2009)

### SUMMARY OF INVENTION

### Technical Problem

However, in a case in which the work robot disclosed in Patent Literature 1 is manufactured, it is necessary to perform an operation of disposing wires in a space inside a robot arm and connecting the wires between an electrode provided in a motor or the like and an input electrode or the like from the outside of the robot arm. Also, since a space through which the wires pass is required in the robot arm, the robot arm increases in size.

Further, since the robot arm is driven by a motor, there is a problem that noise caused by the motor is emitted from the wires in the robot arm to the outside. In other words, although the wires in the robot arm require a measure against the noise, there is a problem that in a case in which a structure for a measure against the noise is employed, the wire structure becomes complicated.

The present invention was made in view of the aforementioned problem, and an objective thereof is to provide a robot arm that realizes assembly cost reduction, size reduction of the apparatus, and also a measure against noise and a manufacturing method thereof.

### Solution to Problem

In order to solve the aforementioned problem, a robot arm according to an aspect of the present invention includes: an arm member configured with a resin to be solid; and at least two wires embedded in the resin configuring the arm member and configured with a conductive material, the two wires having a configuration in which (1) each wire has a flat shape and the wires are disposed in parallel in a state of facing each other in a direction perpendicular to a face of the flat shape, (2) a shield wire is provided around each wire, (3) each wire has a helical shape, or (4) the wires are twisted together.

In order to solve the aforementioned problem, a robot arm manufacturing method according to an aspect of the present invention is a robot arm manufacturing method of manufacturing a robot arm using a three-dimensional shaping apparatus configured to shape a three-dimensionally shaped article by stacking a shaping material, the method including: stacking the shaping material including a resin and a conductive material such that at least two wires configured with the conductive material are embedded in an arm member configured with the resin to be solid, the stacking being performed such that the two wires have a configuration in which (1) each wire has a flat shape and the wires are disposed in parallel in a state of facing each other in a direction perpendicular to a face of the flat shape, (2) a shield wire is provided around each wire, (3) each wire has a helical shape, or (4) the wires are twisted together.

### Advantageous Effects of Invention

According to an aspect of the present invention, it is possible to provide a robot arm that realizes assembly cost reduction, a size reduction of the apparatus, and also a measure against noise and a manufacturing method thereof.

### BRIEF DESCRIPTION OF DRAWINGS

(a) to (d) of FIG. 1 are perspective views illustrating an example of a wire structure of a robot arm according to an embodiment.

FIG. 2 is a diagram illustrating an example of a configuration of a robot according to the embodiment.

FIG. 3 is a diagram illustrating how an arm member and a drive unit are connected to each other in the robot arm.

FIG. 4 is a diagram illustrating how two arm members are connected to each other in the robot arm.

FIG. 5 is a diagram illustrating how two arm members are connected to each other in a robot arm according to a modification example of the robot arm illustrated in FIG. 4.

(a) and (b) of FIG. 6 are sectional views illustrating a section perpendicular to a cylindrical face of a second arm member-side recessed portion in the robot arm illustrated in FIG. 5.

FIG. 7 is a diagram illustrating a robot arm configured such that an arm member including the wire illustrated in (a) of FIG. 1 is fitted into a tubular metal member.

FIG. 8 is a diagram illustrating how surroundings of the arm member including the wire illustrated in (a) of FIG. 1 are covered with a shield wire.

### DESCRIPTION OF EMBODIMENTS

### Embodiment

An embodiment according to an aspect of the present invention (hereinafter, also referred to as the “present embodiment”) will be described on the basis of the drawings. First, an example of a situation to which an aspect of the present invention is applied will be described. A robot arm according to an aspect of the present invention is shaped using a three-dimensional shaping apparatus such as a 3D printer (three-dimensional shaping machine). Specifically, the robot arm is manufactured by stacking a shaping material including an insulating material or a conductive material using the three-dimensional shaping apparatus. The three-dimensional shaping apparatus is an apparatus that shapes a three-dimensionally shaped article by stacking a shaping material.

An arm member 10, first arm members 10a and 10c, second arm members 10b and 10d, wires 20 and 20a to 20d, a shield wire S1, arm-side electrodes E1 and E11, first arm member-side electrodes E3, E4, E7, and E8, second arm-side electrodes E5, E6, E9, and E10, a projecting portion 14, elastic portions 40a and 40b, and a shield wire 60, which will be described later, are shaped by the three-dimensional shaping apparatus.

(Example of Configuration of Robot)

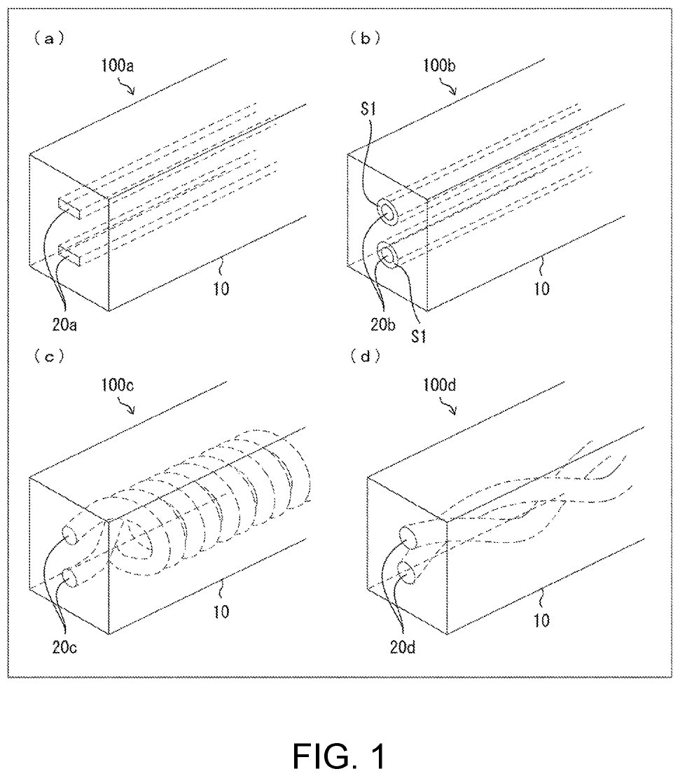

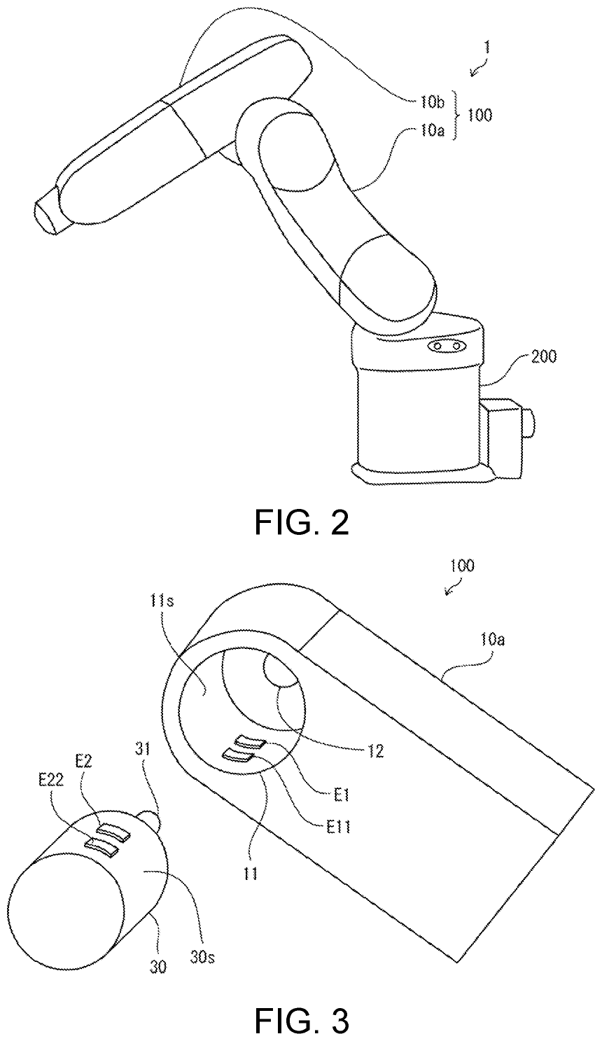

FIG. 2 is a diagram illustrating an example of a configuration of a robot 1 according to the present embodiment. The robot 1 includes a robot arm 100 and a main body portion 200 as illustrated in FIG. 2. A wire structure inside the robot arm 100 may be any of wire structures inside robot arms 100a to 100d illustrated in (a) to (d) of FIG. 1. The robot arm 100 includes a first arm member 10a and a second arm member 10b. The first arm member 10a and the second arm member 10b are rotatably connected to each other in a state in which at least a part of the first arm member 10a and at least a part of the second arm member 10b overlap each other. Also, although the robot arm 100 includes the two arm members, the robot arm 100 may include three or more arm members.

The first arm member 10a and the second arm member 10b have configurations similar to that of the arm member 10, which will be described later. The second arm member 10b is connected to the main body portion 200, and control equipment configured to control the robot 1 is provided inside the main body portion 200.

(a) to (d) of FIG. 1 are perspective views illustrating an example of a wire structure of the robot arms 100a to 100d according to the present embodiment. Also, (a) to (d) of FIG. 1 illustrate sections of the robot arms 100a to 100d at predetermined positions.

(Example of Wire Structure of Robot Arm)

The robot arm 100a includes an arm member 10 and at least two wires 20a as illustrated in (a) of FIG. 1. The at least two wires 20a are embedded in the arm member 10. Each of the two wires 20a has a flat shape, and the two wires 20a are disposed in parallel with each other in a state in which the two wires 20a face each other in a direction perpendicular to the flat shape faces. Also, the two wires 20a may not be disposed in exactly parallel with each other to such an extent that electrostatic capacitance is generated therebetween.

The arm member 10 is an insulating material and is configured with a resin, for example, to be solid. Also, “configured to be solid” includes a configuration in which the wires 20a are embedded in the resin as a material for maintaining structural strength of the arm member 10. For example, a shape recessed inward from the side face of the arm member 10 in (a) of FIG. 1 may be employed. Further, a shape obtained by the recessed shape extending up to a portion between the two wires 20a may also be employed. In this case, it is possible to provide an air layer between the two wires 20a. Also, although the sectional shape of the arm member 10 is a rectangular shape in (a) to (d) of FIG. 1, the sectional shape may be a circular shape, an oval shape, or another shape, for example. In this manner, the sectional shape of the arm member 10 is not particularly limited.

The wires 20a are configured with a conductive material. The wires 20a are for transmitting power and signals to each component (such as a drive unit 30, which will be described later) electrically connected to the wires 20a in the robot arm 100a. Details related to the wires 20a described here are also applicable to wires 20 and 20b to 20d, which will be described later.

Since the wires 20a are already embedded in the arm member 10 in this manner, it is possible to reduce the operation of connecting the wires 20a and to realize manufacturing cost reduction. Also, since it is not necessary to provide a coating film for covering the wires 20a, it is possible to reduce the robot arm 100a in size in accordance with the amount corresponding to the unnecessary coating film. In addition, since the wires 20a are embedded in the arm member 10, it is possible to reduce a likelihood that the wires 20a are disconnected, and it is not necessary for wires to be disposed in a space inside the robot arm 100a. Further, since the conductive material is embedded in the resin configuring the arm member 10, it is possible to improve a reinforcing effect of the arm member 10 with the conductive material.

Also, each of the two wires 20a has a flat shape, and the two wires 20a are disposed in parallel with each other in a state in which the two wires 20a face each other in a direction perpendicular to the flat shape faces. Therefore, it is possible to adjust the electrostatic capacitance between the two wires 20a by adjusting the distance between the two wires 20a and the width of the two wires 20a. It is possible to adjust the electrostatic capacitance between the two wires 20a in this manner and thereby to curb noise output from the wires 20a to the outside. Also, it is possible to curb influences of noise from the outside on a current flowing through the wires 20a. The width is a length in a direction that is perpendicular to a direction in which the wires 20a extend (the longitudinal direction of the wires 20a) and is parallel to the flat shape faces.

A robot arm 100b is different from the robot arm 100a in that the at least two wires 20a are changed to at least two wires 20b and that shield wires S1 are provided around the two wires 20b as illustrated in (b) of FIG. 1. The shield wires S1 can curb noise output from the wires 20b to the outside by the shield wires S1 being provided around the wires 20b. Also, it is possible to curb influences of noise from the outside on a current flowing through the wires 20b.

Also, a structure in which the at least two wires 20b are collectively covered with the shield wire S1 may also be employed instead of the structure in which the shield wire S1 is provided around each of the at least two wires 20b.

A robot arm 100c is different from the robot arm 100a in that the at least two wires 20a are changed to at least two wires 20c and each of the two wires 20c has a helical shape as illustrated in (c) of FIG. 1. It is possible to curb noise output from the wire 20c to the outside and to curb influences of noise from the outside on a current flowing through the wires 20c by each of the two wires 20c having a helical shape. Also, it is possible to adjust inductance of the wires 20c by changing the number of windings of the helical wires 20c, thereby to further curb noise output from the wires 20c to the outside, and to further curb influences of noise from the outside on the current flowing through the wires 20c.

Although (c) of FIG. 1 illustrates the case in which the number of wires 20c is two, a configuration in which one wire 20c has a helical shape may be employed. Also, a configuration in which the two wires 20c have a helical shape at mutually different positions may also be employed.

A robot arm 100d is different from the robot arm 100a in that the at least two wires 20a are changed to at least two wires 20d, and the two wires 20d are twisted together as illustrated in (d) of FIG. 1. It is possible to curb noise output from the wire 20d to the outside by the two wires 20d being twisted together. Also, it is possible to curb influences of noise from the outside on a current flowing through the wires 20d.

As described above, since a motor is used to drive the robot arm, for example, there may be a case in which noise generated by the motor is transmitted to the wires and is emitted from the wires to the outside. On the other hand, since the configurations of the wires 20a to 20d have structures capable of curbing noise emission to the outside, it is possible to provide the robot arms 100a to 100d curbing noise emission to the outside. Also, the electrostatic capacitance of the wires 20a and the inductance of the wires 20c have effects of storing energy such as magnetic fields or electric fields. In this manner, it is possible to achieve accumulation of regenerative power at the time of stopping the operations of the robot arms 100a to 100d and instantaneous emission of power running power at the time of accelerating the operations of the robot arms 100a to 100d.

(Example of Robot Arm Manufacturing Method)

The aforementioned robot arms 100a to 100d are shaped using the three-dimensional shaping apparatus. Specifically, a shaping material including a resin and a conductive material is stacked such that at least two wires configured with the conductive material are embedded in the arm member 10 configured with the resin to be solid (stacking process). The wires may be any of the wires 20a to 20d.

At the time of stacking the shaping material, the stacking is performed such that the two wires have the following configurations (1) to (4). (1) A configuration in which each of the two wires 20a has a flat shape and the wires are disposed in parallel in a state of facing each other in a direction perpendicular to the flat shape face. (2) A configuration in which the shield wire S1 is provided around each of the two wires 20b. (3) A configuration in which each of the two wires 20c has a helical shape. (4) A configuration in which the two wires 20d are twisted together.

(Example of Configuration of Robot Arm)

FIG. 3 is a diagram illustrating how the first arm member 10a and a drive unit 30 are connected to each other in the robot arm 100. The robot arm 100 includes the drive unit 30 as illustrated in FIG. 3. The drive unit 30 is fitted to the arm-side recessed portion 11 formed in a side face of the first arm member 10a. In other words, the drive unit 30 is attached to the first arm member 10a. The drive unit 30 drives and rotates the second arm member 10b connected to the first arm member 10a. Although the drive unit 30 may be, for example, a motor, the drive unit 30 is not particularly limited as long as the drive unit 30 can cause the second arm member 10b to rotate.

A cylindrical face 11s is formed in the arm-side recessed portion 11. The cylindrical face 11s of the first arm member 10a is provided with arm-side electrodes E1 and E11, and each of the arm-side electrodes E1 and E11 is integrated with the wire 20 embedded in the first arm member 10a. In other words, each of the arm-side electrodes E1 and E11 is continuously configured with the same material as that of the wires 20. The structure of the wires 20 may be any of the structures of the wires 20a to 20d illustrated in (a) to (d) of FIG. 1. A cylindrical face 30s of the drive unit 30 is provided with drive unit-side electrodes E2 and E22. Also, the cylindrical face 11s of the first arm member 10a may be provided with three or more arm-side electrodes.

The arm-side electrodes E1 and E11 are electrically connected to the drive unit-side electrode E2 and E22, respectively, by the drive unit 30 being fitted into the arm-side recessed portion 11. In other words, the arm-side electrodes E1 and E11 are electrically connected to the drive unit-side electrodes E2 and E22 by the drive unit 30 being attached to the first arm member 10a.

Since the arm-side electrodes E1 and E11 are electrically connected to the drive unit-side electrodes E2 and E22 by the drive unit 30 being attached to the first arm member 10a, a connecting portion between the first arm member 10a and the drive unit 30 can have a simple structure. For example, a complicated structure as in a robot arm in the related art in which a plurality of wires is jumbled up from the drive unit to the control equipment due to wire connection between the arm-side electrodes and the drive unit-side electrodes is not achieved. Also, it is not necessary to provide wires to connect the arm-side electrodes E1 and E11 to the drive unit-side electrodes E2 and E22. Therefore, it is possible to reduce the operation of connecting wires.

Also, a joint shaft 31 of the drive unit 30 passes through an opening 12 formed in a bottom face of the arm-side recessed portion 11 by the drive unit 30 being fitted into the arm-side recessed portion 11. The joint shaft 31 passing through the opening 12 is connected to the second arm member 10b. The drive unit 30 drives and rotates the second arm member 10b by causing the joint shaft 31 to rotate. The joint shaft 31 is for mutually rotating the first arm member 10a and the second arm member 10b. In this manner, the robot arm 100 includes the joint shaft 31.

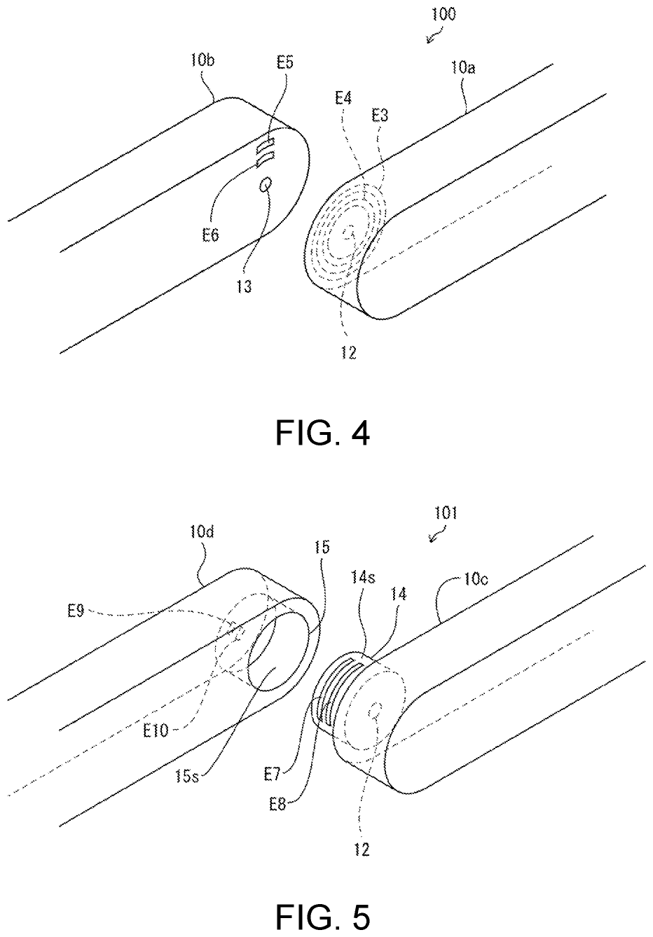

FIG. 4 is a diagram illustrating how the first arm member 10a and the second arm member 10b are connected to each other in the robot arm 100. In FIG. 4, the arm-side recessed portion 11 and the drive unit 30 illustrated in FIG. 3 are omitted. The aforementioned joint shaft 31 is connected to the second arm member 10b by passing through the opening 12 and entering an opening 13 formed in a side face of the second arm member 10b.

Also, in the robot arm 100, first arm member-side electrodes E3 and E4 are provided in a side face of the first arm member 10a perpendicular to the axial direction of the joint shaft 31, and second arm member-side electrodes E5 and E6 are provided in a side face of the second arm member 10b perpendicular to the axial direction of the joint shaft 31. In this manner, the structure in which the first arm member-side electrodes E3 and E4 and the second arm member-side electrodes E5 and E6 are caused to slide in a state in which conduction therebetween is maintained can be a simple structure. For example, a complicated structure as in the robot arm in the related art in which a plurality of wires is jumbled at the connecting portion between the first arm member and the second arm member due to wire connection between the first arm member-side electrode and the second arm member-side electrode is not achieved.

Also, although the first arm member 10a and the second arm member 10b are disposed relative to the joint shaft 31 in a manner in which the first arm member 10a and the second arm member partially overlapping each other in a direction perpendicular to the longitudinal direction of the first arm member 10a and the second arm member 10b in the configuration in the example illustrated in FIG. 4, the present invention is not limited thereto. For example, a case in which the first arm member 10a and the second arm member 10b are disposed in an overlapping manner in the longitudinal direction of the first arm member 10a and the second arm member 10b will be considered. In this case, a configuration in which two projecting portions are formed in the first arm member 10a, a projecting portion formed in the second arm member 10b is sandwiched between the two projecting portions, and the joint shaft 31 is provided to penetrate through these projecting portions may be employed. Also, a configuration in which a plurality of projecting portions is formed in each of the first arm member 10a and the second arm member 10b and the joint shaft 31 is provided to penetrate through the plurality of projecting portions at portions at which the projecting portions are alternately meshed with each other may be employed.

Further, when the first arm member 10a and the second arm member 10b mutually rotate, the first arm member-side electrode E3 slides in a state in which the first arm member-side electrode E3 maintains conduction with the second arm member-side electrode E5, and the first arm member-side electrode E4 slides in a state in which the first arm member-side electrode E4 maintains conduction with the second arm member-side electrode E6. In addition, each of the first arm member-side electrodes E3 and E4 is integrated with the wire 20 embedded in the first arm member 10a, and each of the second arm member-side electrodes E5 and E6 is integrated with the wire 20 embedded in the second arm member 10b. In other words, each of the first arm member-side electrodes E3 and E4 is continuously configured with the same material as that of the wire 20 embedded in the first arm member 10a. Moreover, each of the second arm member-side electrodes E5 and E6 is continuously configured with the same material as that of the wire 20 embedded in the second arm member 10b.

In this manner, it is not necessary to provide a wire to connect the wire 20 embedded in the first arm member 10a to the wire 20 embedded in the second arm member 10b. Therefore, it is possible to reduce the operation of connecting wires and to reduce the likelihood that the wires are disconnected. Also, it is possible to maintain the conduction even when the first arm member 10a and the second arm member 10b mutually rotate. In this manner, it is possible to obtain the following effects as compared with a case in which a wire to connect the wire 20 embedded in the first arm member 10a to the wire 20 embedded in the second arm member 10b is provided.

Specifically, it is possible to prevent a movable range related to rotation of the joint shaft 31 between the first arm member 10a and the second arm member 10b from being limited and to prevent the apparatus from increasing in size by providing a margin for the length of the wire to allow rotation of the joint shaft 31, for example.

Also, although the two first arm member-side electrodes E3 and E4 are provided in the side face of the first arm member 10a in FIG. 4, three or more first arm member-side electrodes may be provided in the side face of the first arm member 10a. Also, although the two second arm member-side electrodes E5 and E6 are provided in the side face of the second arm member 10b, three or more second arm member-side electrode may be provided in the side face of the second arm member 10b.

Also, each of the first arm member-side electrodes E3 and E4 may be a slip ring, and each of the second arm member-side electrodes E5 and E6 may be a brush. On the contrary, each of the first arm member-side electrodes E3 and E4 may be a brush, and each of the second arm member-side electrodes E5 and E6 may be a slip ring.

In this manner, the connecting portion of the wires 20 between the first arm member 10a and the second arm member 10b can have a simple structure. For example, a complicated structure as in the robot arm in the related art in which a plurality of wires is jumbled at the connecting portion between the first arm member and the second arm member is not achieved.

In addition, since the brush and the slip ring are integrated with the wires 20 embedded in the first arm member 10a and the second arm member 10b, portions that slide in a state in which the brush and the slip ring maintain conduction can have a simple structure. For example, a complicated structure in which the brush, the slip ring, and the wires are separately provided is not achieved as compared with the robot arm in the related art.

FIG. 5 is a diagram illustrating how a first arm member 10c and a second arm member 10d are connected to each other in a robot arm 101 according to a modification example of the robot arm 100 illustrated in FIG. 4. The robot arm 101 is different from the robot arm 100 in that the first arm member-side electrodes E3 and E4 are changed to the first arm member-side electrodes E7 and E8, respectively, and the second arm member-side electrodes E5 and E6 are changed to the second arm member-side electrodes E9 and E10, respectively, as illustrated in FIG. 5. In addition, the robot arm 101 is different from the robot arm 100 in that a projecting portion 14 is provided in a side face of the first arm member 10c and a second arm member-side recessed portion 15 is formed in a side face of the second arm member 10d.

A cylindrical projecting portion 14 that is coaxial with the joint shaft 31 is provided in the side face of the first arm member 10c, and the second arm member-side recessed portion 15 is formed in the side face of the second arm member 10d. The projecting portion 14 is fitted into the second arm member-side recessed portion 15.

Also, a joint shaft 31 (not illustrated) of a drive unit 30 passes through an opening 12 of the first arm member 10c and penetrates through the projecting portion 14. The joint shaft 31 is connected to the second arm member 10d. In this manner, the second arm member-side recessed portion 15 slides with the projecting portion 14 in a state in which the projecting portion 14 is fitted into the second arm member-side recessed portion 15 by the drive unit 30 (not illustrated) provided in the first arm member 10c rotating the joint shaft 31.

In the robot arm 101, first arm member-side electrodes E7 and E8 are provided in a cylindrical face 14s of the projecting portion 14, and second arm member-side electrodes E9 and E10 are provided in a cylindrical face 15s of the second arm member-side recessed portion 15. In this manner, the connecting portion between the first arm member 10c and the second arm member 10d can have a simple structure. Also, the structure of causing each of the first arm member-side electrodes E7 and E8 and each of the second arm member-side electrodes E9 and E10 to slide in a state in which conduction therebetween is maintained can be a simple structure. For example, a complicated structure as in the robot arm in the related art in which a plurality of wires is jumbled at the connecting portion between the first arm member and the second arm member is not achieved.

Also, although the two first arm member-side electrodes E7 and E8 are provided in the cylindrical face 14s of the projecting portion 14 in FIG. 5, three or more first arm member-side electrodes may be provided in the cylindrical face 14s of the projecting portion 14. Also, although the two second arm member-side electrodes E9 and E10 are provided in the cylindrical face 15s of the second arm member-side recessed portion 15, three or more second arm member-side electrodes may be provided in the cylindrical face 15s of the second arm member-side recessed portion 15.

Also, each of the first arm member-side electrodes E7 and E8 may be a slip ring, and each of the second arm member-side electrodes E9 and E10 may be a brush. On the contrary, each of the first arm member-side electrodes E7 and E8 may be a brush, and each of the second arm member-side electrodes E9 and E10 may be a slip ring.

(a) and (b) of FIG. 6 are sectional views illustrating a section of the robot arm 101 illustrated in FIG. 5 perpendicular to the cylindrical face 15s of the second arm member-side recessed portion 15. As illustrated in (a) and (b) of FIG. 6, elastic portions 40a and 40b with elasticity are provided in the cylindrical face 15s (front face) of the second arm member-side recessed portion 15 in the robot arm 101. The second arm member-side electrode E9 is formed in the front faces of the elastic portions 40a and 40b. The second arm member-side electrode E10 also has a structure in which the second arm member-side electrode E10 is formed in the front faces of the elastic portions 40a and 40b. The second arm member-side electrodes E9 and E10 are conductive materials.

Also, the second arm member-side electrodes E5 and E6 of the robot arm 101 illustrated in FIG. 4 may have a structure in which the second arm member-side electrodes E5 and E6 are formed in the front faces of the elastic portions 40a and 40b. Further, even in a case in which the first arm member-side electrodes E3, E4, E7, and E8 are brushes, a structure in which the first arm member-side electrodes E3, E4, E7, and E8 are formed in the front faces of the elastic portions 40a and 40b may be employed. Therefore, the elastic portion 40a or the elastic portion 40b can cause the slip rings and the brushes to come into strong contact with each other, by the elastic portions 40a and 40b being provided on the front face of the first arm member 10c or the second arm member 10d.

As illustrated in (a) of FIG. 6, the elastic portion 40a is inclined relative to the cylindrical face 15s of the second arm member-side recessed portion 15 and projects from the cylindrical face 15s. Also, the elastic portion 40a extends obliquely upward relative to the cylindrical face 15s. In addition, as illustrated in (b) of FIG. 6, the elastic portion 40b has a mountain shape, and a space between the elastic portion 40b and the cylindrical face 15s serves as a moving space using elastic deformation. The wire 20 embedded in the second arm member 10d passes through the elastic portion 40b and is integrated with the second arm member-side electrode E9.

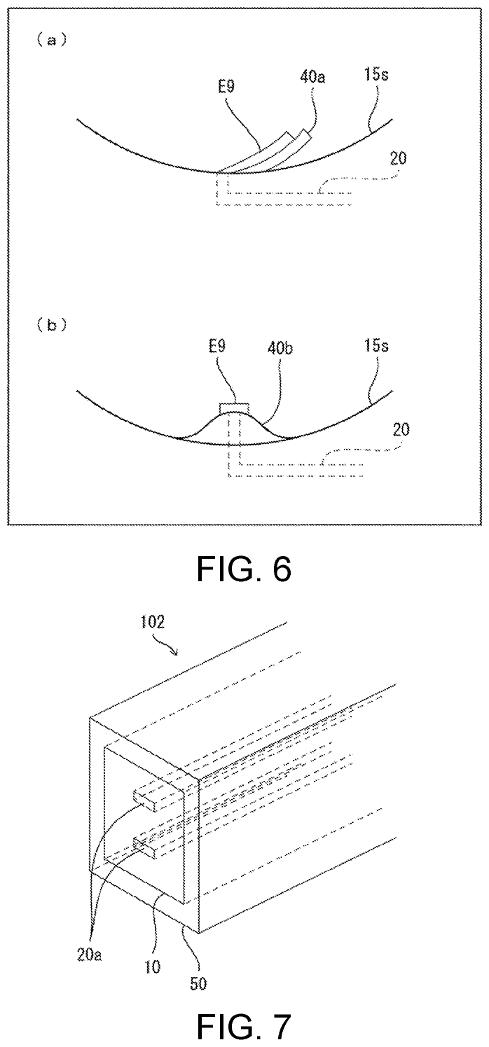

FIG. 7 is a diagram illustrating a robot arm 102 in which an arm member 10 including a wire 20a is fitted into a tubular metal member 50 as illustrated in (a) of FIG. 1. The robot arm 102 includes a tubular metal member 50 as illustrated in FIG. 7. The metal member 50 may be, for example, a metal pipe. In other words, the arm member 10 is provided with the metal member 50 as a reinforcing member made of metal.

In this manner, the robot arm 102 can have a stronger structure by the arm member 10 provided with the reinforcing member made of metal. Also, it is possible to relatively easily realize the configuration by fitting the arm member 10 made of a resin into the tubular metal member 50.

Also, the aforementioned first arm members 10a and 10c and the second arm members 10b and 10d may be fitted into the metal member 50. Also, the arm member 10 including the aforementioned at least two wires (any of the wires 20b to 20d) may be fitted into the metal member 50.

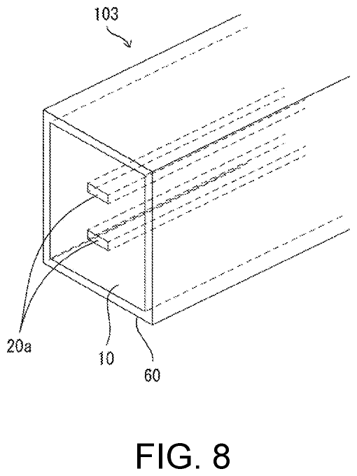

FIG. 8 is a diagram illustrating how the surroundings of the arm member 10 including the wire 20a illustrated in (a) of FIG. 1 are covered with the shield wire 60. The robot arm 103 includes the shield wire 60 as illustrated in FIG. 8. The shield wire 60 covers the surroundings of the arm member 10. In other words, the shield wire 60 is formed in the front face of the arm member 10. It is thus possible to curb noise output from the wire 20a to the outside by the surroundings of the arm member 10 being covered with the shield wire 60. Also, it is possible to curb influences of noise from the outside on a current flowing through the wire 20a.

The configuration illustrated in FIG. 8 is shaped by the three-dimensional shaping apparatus. Specifically, a shaping material including a resin and a conductive material is stacked such that the shield wire 60 configured with the conductive material is formed in the outer face of the arm member 10 configured with the resin to be solid.

Also, the surroundings of the aforementioned first arm members 10a and 10c and the second arm members 10b and 10d may be covered with the shield wire 60. Also, the surrounding of the arm member 10 including the aforementioned at least two wires (any of the wires 20b to 20d) may be covered with the shield wire 60.

### CONCLUSION

A robot arm according to an aspect of the present invention includes: an arm member configured with a resin to be solid; and at least two wires embedded in the resin configuring the arm member and configured with a conductive material, the two wires having a configuration in which (1) each wire has a flat shape and the wires are disposed in parallel in a state of facing each other in a direction perpendicular to a face of the flat shape, (2) a shield wire is provided around each wire, (3) each wire has a helical shape, or (4) the wires are twisted together.

With the aforementioned configuration, since the wires are already embedded in the resin configuring the arm member, it is possible to reduce the operation of connecting the wires and to realize manufacturing cost reduction. Since the coating film covering the wires is not needed, it is possible to reduce the robot arm in size by the amount corresponding to the unnecessary coating film. Also, since the wires are embedded in the arm member, it is possible to reduce a likelihood that the wires are disconnected, and it is not necessary to provide a wire disposed in a space in the robot arm. Moreover, since the conductive material is embedded in the resin configuring the arm member, it is possible to improve an effect of reinforcing the arm member with the conductive material.

Also, since the motor is used for driving the robot arm, for example, there is a case in which noise generated by the motor is transmitted to the wires and is emitted from the wires to the outside. On the other hand, the aforementioned configurations (1) to (4) are structures capable of curbing emission of noise to the outside and curbing influences of noise from the outside on the current flowing through the wires. Therefore, it is possible to provide a robot arm curbing noise emission to the outside and influences of noise from the outside.

Two of the arm members may be referred to as a first arm member and a second arm member, and the first arm member and the second arm member may be rotatably connected to each other in a state in which at least a part of the first arm member and at least a part of the second arm member overlap each other, and a first arm member-side electrode that is integrated with the wire embedded in the first arm member may slide in a state in which the first arm member-side electrode is maintained to be conductive with a second arm member-side electrode that is integrated with the wire embedded in the second arm member when the first arm member and the second arm member mutually rotate.

With the aforementioned configuration, the first arm member-side electrode that is integrated with the wire embedded in the first arm member slides in a state in which the first arm member-side electrode maintains conduction with the second arm member-side electrode that is integrated with the wire embedded in the second arm member. Therefore, it is not necessary to provide a wire to connect the wire embedded in the first arm member to the wire embedded in the second arm member. It is thus possible to reduce the operation of connecting the wires and to reduce the likelihood that the wires are disconnected.

Also, it is possible to maintain conductivity even when the first arm member and the second arm member mutually rotate. In this manner, the following effects are obtained as compared with a case in which a wire to connect the wire embedded in the first arm member to the wire embedded in the second arm member is provided. Specifically, it is possible to prevent a movable range related to rotation of the joint shaft between the first arm member and the second arm member from being limited and to prevent the apparatus from increasing in size by providing a margin for the length of the wire to allow rotation of the joint shaft, for example.

One of the first arm member-side electrode and the second arm member-side electrode may be a slip ring, and the other one of the first arm member-side electrode and the second arm member-side electrode may be a brush.

With the aforementioned configuration, the connecting portion of the wires between the two arm members can have a simple structure. Also, since the brush and the slip ring are integrated with the wires embedded in the two arm members, the portions sliding in a state in which the brush and the slip ring maintain conductivity can have a simple structure.

The robot arm may further include: a drive unit attached to the first arm member and configured to drive and rotate the second arm member, and an arm-side electrode that is provided in the first arm member and is integrated with the wire embedded in the first arm member may be electrically connected to a drive unit-side electrode provided in the drive unit by the drive unit being attached to the first arm member. Although the drive unit may be, for example, a motor, the drive unit is not particularly limited as long as the drive unit can cause the second arm member to rotate.

With the aforementioned configuration, since the arm-side electrode and the drive unit-side electrode are electrically connected to each other by the drive unit being attached to the first arm member, the connecting portion between the first arm member and the drive unit can have a simple structure. Also, it is not necessary to provide a wire to connect the arm-side electrode to the drive unit-side electrode. Therefore, it is possible to reduce the operation of connecting the wires.

The robot arm may include: a joint shaft causing the first arm member and the second arm member to mutually rotate, and the first arm member-side electrode may be provided in a side face of the first arm member perpendicular to an axial direction of the joint shaft, and the second arm member-side electrode is provided in a side face of the second arm member perpendicular to the axial direction of the joint shaft. With the aforementioned configuration, a structure of causing the first arm member-side electrode and the second arm member-side electrode to slide in a state in which conduction is maintained therebetween can be a simple structure.

The robot arm may include: a joint shaft causing the first arm member and the second arm member to mutually rotate, a projecting portion with a cylindrical shape that is coaxial with the joint shaft may be provided in a side face of the first arm member, and a second arm member-side recessed portion configured to slide along the projecting portion may be formed in a side face of the second arm member, and the first arm member-side electrode may be provided in a cylindrical face of the projecting portion, and the second arm member-side electrode may be provided in a cylindrical face of the second arm member-side recessed portion.

With the aforementioned configuration, the connecting portion between the first arm member and the second arm member can have a simple structure. Also, the structure of causing the first arm member-side electrode and the second arm member-side electrode to slide in a state in which conduction is maintained therebetween can have a simple structure.

The robot arm according to claim 3, in which the brush is a conductive material formed in a face of an elastic portion with elasticity provided in a face of the first arm member or the second arm member. With the aforementioned configuration, the elastic portion can cause the slip ring and the brush to come into strong contact with each other.

The arm member may be provided with a reinforcing member made of metal. According to the aforementioned configuration, since the arm member is provided with the reinforcing member made of metal, the robot arm can have a stronger structure. Also, it is possible to relatively easy realize the configuration by fitting the arm member made of a resin into a tubular metal member, for example.

A robot arm manufacturing method according to an aspect of the present invention is a robot arm manufacturing method of manufacturing a robot arm using a three-dimensional shaping apparatus configured to shape a three-dimensionally shaped article by stacking a shaping material, the method including: stacking the shaping material including a resin and a conductive material such that at least two wires configured with the conductive material are embedded in an arm member configured with the resin to be solid, the stacking being performed such that the two wires have a configuration in which (1) each wire has a flat shape and the wires are disposed in parallel in a state of facing each other in a direction perpendicular to a face of the flat shape, (2) a shield wire is provided around each wire, (3) each wire has a helical shape, or (4) the wires are twisted together.

With the aforementioned configuration, the aforementioned configurations (1) to (4) are structures capable of curbing emission of noise to the outside and influences of noise from the outside on the current flowing through the wires. Therefore, it is possible to provide a robot arm curbing noise emission to the outside and influences of noise from the outside.

In the robot arm manufacturing method, the stacking includes forming two arm members which are a first arm member and a second arm member, the method further includes attaching a drive unit configured to drive and rotate the second arm member to the first arm member, and the attaching of the drive unit to the first arm member is performed such that an arm-side electrode that is provided in the first arm member and is integrated with the wire embedded in the first arm member is electrically connected to a drive unit-side electrode provided in the drive unit.

With the aforementioned configuration, it is possible to easily attach the drive unit to the first arm member without performing soldering, for example, by attaching the drive unit to the first arm member such that the arm-side electrode is electrically connected to the drive unit-side electrode.

The present invention is not limited to each of the aforementioned embodiments, various modifications can be made within the scope defined by the claims, and embodiments obtained by appropriately combining technical means disclosed in different embodiments are also included within the technical scope of the present invention.

### REFERENCE SIGNS LIST

10 Arm member
10a, 10c First arm member
10b, 10d Second arm member
14s, 15s Cylindrical face
14 Projecting portion
15 Second arm member-side recessed portion
20, 20a, 20b, 20c, 20d Wire
30 Drive unit
31 Joint shaft
40a, 40b Elastic portion
100, 100a, 100b, 100c, 100d, 101, 102 Robot arm
E1, E11 Arm-side electrode
E2, E22 Drive unit-side electrode
E3, E4, E7, E8 First arm member-side electrode
E5, E6, E9, E10 Second arm member-side electrode
S1 Shield wire

1. A robot arm comprising:
an arm member configured with a resin to be solid; and
at least two wires embedded in the resin configuring the arm member and configured with a conductive material,
wherein the two wires have a configuration in which
(1) each wire has a flat shape and the wires are disposed in parallel in a state of facing each other in a direction perpendicular to a face of the flat shape,
(2) a shield wire is provided around each wire,
(3) each wire has a helical shape, or
(4) the wires are twisted together.

2. The robot arm according to claim 1,
wherein two of the arm members are referred to as a first arm member and a second arm member, and
the first arm member and the second arm member are rotatably connected to each other in a state in which at least a part of the first arm member and at least a part of the second arm member overlap each other, and
a first arm member-side electrode that is integrated with the wire embedded in the first arm member slides in a state in which the first arm member-side electrode is maintained to be conductive with a second arm member-side electrode that is integrated with the wire embedded in the second arm member when the first arm member and the second arm member mutually rotate.

3. The robot arm according to claim 2, wherein one of the first arm member-side electrode and the second arm member-side electrode is a slip ring, and the other one of the first arm member-side electrode and the second arm member-side electrode is a brush.

4. The robot arm according to claim 2, further comprising:
a drive unit attached to the first arm member and configured to drive and rotate the second arm member,
wherein an arm-side electrode that is provided in the first arm member and is integrated with the wire embedded in the first arm member is electrically connected to a drive unit-side electrode provided in the drive unit by the drive unit being attached to the first arm member.

5. The robot arm according to claim 2, comprising:
a joint shaft causing the first arm member and the second arm member to mutually rotate,
wherein the first arm member-side electrode is provided in a side face of the first arm member perpendicular to an axial direction of the joint shaft, and the second arm member-side electrode is provided in a side face of the second arm member perpendicular to the axial direction of the joint shaft.

6. The robot arm according to claim 2, comprising:
a joint shaft causing the first arm member and the second arm member to mutually rotate,
wherein a projecting portion with a cylindrical shape that is coaxial with the joint shaft is provided in a side face of the first arm member, and a second arm member-side recessed portion configured to slide along the projecting portion is formed in a side face of the second arm member, and
the first arm member-side electrode is provided in a cylindrical face of the projecting portion, and the second arm member-side electrode is provided in a cylindrical face of the second arm member-side recessed portion.

7. The robot arm according to claim 3, wherein the brush is a conductive material formed in a face of an elastic portion with elasticity provided in a face of the first arm member or the second arm member.

8. The robot arm according to claim 1, wherein the arm member is provided with a reinforcing member made of metal.

9. A robot arm manufacturing method of manufacturing a robot arm using a three-dimensional shaping apparatus configured to shape a three-dimensionally shaped article by stacking a shaping material, the method comprising:
stacking the shaping material including a resin and a conductive material such that at least two wires configured with the conductive material are embedded in an arm member configured with the resin to be solid,
wherein the stacking is performed such that the two wires have a configuration in which
(1) each wire has a flat shape and the wires are disposed in parallel in a state of facing each other in a direction perpendicular to a face of the flat shape,
(2) a shield wire is provided around each wire,
(3) each wire has a helical shape, or
(4) the wires are twisted together.

10. The robot arm manufacturing method according to claim 9,
wherein the stacking includes forming two arm members which are a first arm member and a second arm member,
the method further comprises attaching a drive unit configured to drive and rotate the second arm member to the first arm member, and
the attaching of the drive unit to the first arm member is performed such that
an arm-side electrode that is provided in the first arm member and is integrated with the wire embedded in the first arm member is electrically connected to a drive unit-side electrode provided in the drive unit.

11. The robot arm according to claim 3, further comprising:
a drive unit attached to the first arm member and configured to drive and rotate the second arm member,
wherein an arm-side electrode that is provided in the first arm member and is integrated with the wire embedded in the first arm member is electrically connected to a drive unit-side electrode provided in the drive unit by the drive unit being attached to the first arm member.

12. The robot arm according to claim 3, comprising:
a joint shaft causing the first arm member and the second arm member to mutually rotate,
wherein the first arm member-side electrode is provided in a side face of the first arm member perpendicular to an axial direction of the joint shaft, and the second arm member-side electrode is provided in a side face of the second arm member perpendicular to the axial direction of the joint shaft.

13. The robot arm according to claim 3, comprising:
a joint shaft causing the first arm member and the second arm member to mutually rotate,
wherein a projecting portion with a cylindrical shape that is coaxial with the joint shaft is provided in a side face of the first arm member, and a second arm member-side recessed portion configured to slide along the projecting portion is formed in a side face of the second arm member, and
the first arm member-side electrode is provided in a cylindrical face of the projecting portion, and the second arm member-side electrode is provided in a cylindrical face of the second arm member-side recessed portion.

14. The robot arm according to claim 4, comprising:
a joint shaft causing the first arm member and the second arm member to mutually rotate,
wherein the first arm member-side electrode is provided in a side face of the first arm member perpendicular to an axial direction of the joint shaft, and the second arm member-side electrode is provided in a side face of the second arm member perpendicular to the axial direction of the joint shaft.

15. The robot arm according to claim 4, comprising:
a joint shaft causing the first arm member and the second arm member to mutually rotate,
wherein a projecting portion with a cylindrical shape that is coaxial with the joint shaft is provided in a side face of the first arm member, and a second arm member-side recessed portion configured to slide along the projecting portion is formed in a side face of the second arm member, and
the first arm member-side electrode is provided in a cylindrical face of the projecting portion, and the second arm member-side electrode is provided in a cylindrical face of the second arm member-side recessed portion.

16. The robot arm according to claim 11, comprising:
a joint shaft causing the first arm member and the second arm member to mutually rotate,
wherein the first arm member-side electrode is provided in a side face of the first arm member perpendicular to an axial direction of the joint shaft, and the second arm member-side electrode is provided in a side face of the second arm member perpendicular to the axial direction of the joint shaft.

17. The robot arm according to claim 11, comprising:
a joint shaft causing the first arm member and the second arm member to mutually rotate,
wherein a projecting portion with a cylindrical shape that is coaxial with the joint shaft is provided in a side face of the first arm member, and a second arm member-side recessed portion configured to slide along the projecting portion is formed in a side face of the second arm member, and
the first arm member-side electrode is provided in a cylindrical face of the projecting portion, and the second arm member-side electrode is provided in a cylindrical face of the second arm member-side recessed portion.
